(19) United States
(12) Patent Application Publication
(10) Pub. No.: US 2021/0323560 A1
(43) Pub. Date: Oct. 21, 2021

(54) VEHICLE SPEED CALCULATION METHOD, SYSTEM, DEVICE, AND STORAGE MEDIUM

(71) Applicant: SZ DJI TECHNOLOGY CO., LTD., Shenzhen (CN)

(72) Inventors: Xinfei LU, Shenzhen (CN); Lei CHEN, Shenzhen (CN); Yiqiang LI, Shenzhen (CN)

(21) Appl. No.: 17/359,366

(22) Filed: Jun. 25, 2021

Related U.S. Application Data
(63) Continuation of application No. PCT/CN2018/124249, filed on Dec. 27, 2018.

(51) Int. Cl. B60W 40/105; G01S 13/58; G01S 13/28; G01S 7/288; G01S 7/292

(52) U.S. Cl. CPC B60W 40/105; G01S 13/584; G01S 7/292; G01S 7/2883; G01S 13/282

(57) ABSTRACT

A vehicle speed calculation system includes a radar mounted at a vehicle and including an antenna used to receive an echo signal, a memory storing a program code, and a processor configured to execute the program code to obtain the echo signal and generate detection data according to the echo signal, determine, according to the detection data, a stationary object around the vehicle and stationary relative to a ground, determine a relative moving speed of the stationary object relative to the vehicle, and determine a vehicle speed of the vehicle according to the relative moving speed of the stationary object.

### CROSS-REFERENCE TO RELATED APPLICATION

This application is a continuation of International Application No. PCT/CN2018/124249, filed Dec. 27, 2018, the entire content of which is incorporated herein by reference.

### TECHNICAL FIELD

The present disclosure relates to the field of vehicles and, in particular, to a vehicle speed calculation method, system, device, and storage medium.

### BACKGROUND

With the development of driving assistance technology and autonomous driving technology, millimeter-wave radars are increasingly used in vehicles. The millimeter-wave radar has the advantages of all-day, all-weather, long range, and high accuracy of speed measurement, etc., which makes up for the shortcomings of other sensors, such as ultrasound sensors and cameras. Generally, the millimeter-wave radar needs a vehicle speed to detect environment surrounding the vehicle. In the existing technology, the millimeter-wave radar arranged at the vehicle is usually connected to an electrical and electronic system of the vehicle through a communication bus to obtain vehicle-related information, for example, the vehicle speed, a turning radius of the vehicle, etc. For example, the millimeter-wave radar can be connected to the vehicle via a controller area network (CAN) bus and obtain relevant information of the vehicle from the CAN bus.

However, there is a certain delay when the CAN bus transmits the vehicle-related information, which disables the millimeter-wave radar to obtain the vehicle-related information in real time, especially the vehicle speed in real time, which has a certain impact on the performance of the millimeter-wave radar. In addition, the millimeter-wave radar connected to the CAN bus is usually used in factory-installed products, that is, the millimeter-wave radar needs to be mounted at the vehicle during a vehicle assembly, and is hard to be used in aftermarket installed products, which is not conducive for follow-up separate uses of the millimeter wave radar.

### SUMMARY

In accordance with the disclosure, there is provided a vehicle speed calculation system including a radar mounted at a vehicle and including an antenna used to receive an echo signal, a memory storing a program code, and a processor configured to execute the program code to obtain the echo signal and generate detection data according to the echo signal, determine, according to the detection data, a stationary object around the vehicle and stationary relative to a ground, determine a relative moving speed of the stationary object relative to the vehicle, and determine a vehicle speed of the vehicle according to the relative moving speed of the stationary object.

Also in accordance with the disclosure, there is provided a vehicle including a vehicle body, a power system mounted at the vehicle body and used to provide power, and a vehicle speed calculation system. The vehicle speed calculation system includes a radar mounted at a vehicle and including an antenna used to receive an echo signal, a memory storing a program code, and a processor configured to execute the program code to obtain the echo signal and generate detection data according to the echo signal, determine, according to the detection data, a stationary object around the vehicle and stationary relative to a ground, determine a relative moving speed of the stationary object relative to the vehicle, and determine a vehicle speed of the vehicle according to the relative moving speed of the stationary object.

Also in accordance with the disclosure, there is provided a vehicle speed calculation method including obtaining an echo signal received by an antenna of a radar at a vehicle and generating detection data according to the echo signal, determining, according to the detection data, a stationary object around the vehicle and stationary relative to a ground, determining a relative moving speed of the stationary object relative to the vehicle, and determining a vehicle speed of the vehicle according to the relative moving speed of the stationary object.

### BRIEF DESCRIPTION OF THE DRAWINGS

FIG. 1 is a schematic diagram showing an example application scenario according to an example embodiment of the present disclosure.

FIG. 2 is a schematic flow chart of a vehicle speed calculation method according to an example embodiment of the present disclosure.

FIG. 3 is a schematic diagram showing two-dimensional data according to an example embodiment of the present disclosure.

FIG. 4 is a schematic diagram showing change of a frequency of a linear frequency-modulated continuous wave with time according to an example embodiment of the present disclosure.

FIG. 5 is a schematic flow chart of a vehicle speed calculation method according to another example embodiment of the present disclosure.

FIG. 6 is a schematic flow chart of a vehicle speed calculation method according to another example embodiment of the present disclosure.

FIG. 7 is a schematic diagram showing two-dimensional data according to an example embodiment of the present disclosure.

FIG. 8 is a schematic diagram showing two-dimensional data according to an example embodiment of the present disclosure.

FIG. 9 is a schematic flow chart of a vehicle speed calculation method according to another example embodiment of the present disclosure.

FIG. 10 is a schematic flow chart of a vehicle speed calculation method according to another example embodiment of the present disclosure.

FIG. 11 is a schematic diagram showing change of a frequency of another linear frequency-modulated continuous wave with time according to an example embodiment of the present disclosure.

FIG. 12 is a schematic structural diagram of a vehicle speed calculation system according to an example embodiment of the present disclosure.

Reference numerals: Vehicle 11; Server 12; Speed unit 71, 72, 73, 7N; Distance unit 81, 82, 83, 8M; Vehicle speed calculation system 120; Radar 121; Memory 122; Processor 123.

### DETAILED DESCRIPTION OF THE EMBODIMENTS

Technical solutions of the present disclosure will be clearly described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The embodiments of the present disclosure are described in detail below with reference to the drawings. When there is no conflict, the following embodiments and features of the embodiments can be combined with each other.

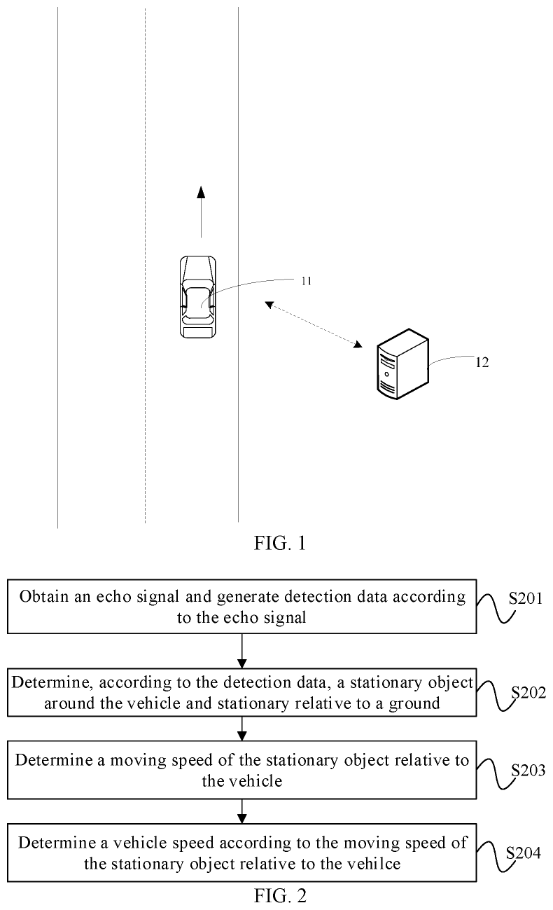

A vehicle speed calculation method consistent with the embodiments of the present disclosure is provided. The method is applied to a vehicle. The vehicle is provided with a radar. In some embodiments, the radar includes a millimeter wave radar. The radar includes at least an antenna. The antenna is used to receive one or more echo signals. FIG. 1 is a schematic diagram of an example application scenario according to an example embodiment of the present disclosure. As shown in FIG. 1, a vehicle 11 travels in a right lane, and the vehicle 11 is provided with a radar. The radar may specifically include a millimeter wave radar. The millimeter wave radar may include a rear-mounted millimeter-wave radar or a front-mounted millimeter-wave radar. Alternately, the millimeter-wave radar may be integrated in the vehicle.

In an example embodiment, the radar may specifically include a frequency-modulated continuous wave (FMCW) radar. In some embodiments, a detection signal of the radar includes a linear frequency-modulated continuous wave. FMCW radar may include an antenna, a radio frequency front terminal, a modulation module, and a signal processing unit. The radio frequency front terminal is used to transmit a detection signal. The detection signal includes a linear frequency-modulated continuous wave, that is, the frequency of the detection signal transmitted by the FMCW radar is linearly modulated. Specifically, the modulation module is used to linearly modulate the frequency of the detection signal transmitted by the FMCW radar. When the detection signal transmitted by the FMCW radar is reflected by an object around the vehicle, the antenna of the FMCW radar receives an echo signal reflected by the object. The signal processing unit of the FMCW radar can process the echo signal to obtain detection data. In some embodiments, the detection data includes at least one of the following: energy of the object around the vehicle, a distance of the object around the vehicle relative to the vehicle, a speed of the object around the vehicle relative to the vehicle, or an angle of the object around the vehicle relative to the vehicle. An object around the vehicle is also referred to as a “nearby object” of the vehicle.

In some embodiments, the FMCW radar may also be in communication with a vehicle-mounted processor. After the antenna of the FMCW radar receives the echo signal, the signal processing unit of the FMCW radar may perform an analog-to-digital conversion on the echo signal. That is, the echo signal is digitally sampled, the sampled echo signal is sent to the vehicle-mounted processor, and the vehicle-mounted processor processes the sampled echo signal to obtain the detection data. After the signal processing unit or the vehicle-mounted processor of the FMCW radar obtains the detection data, the signal processing unit or the vehicle-mounted processor of the FMCW radar can also calculate a vehicle speed according to the detection data.

Alternately, in some embodiments, the FMCW radar is in communication connection with the vehicle-mounted processor. When the signal processing unit of the FMCW radar processes the echo signal to obtain the detection data, the signal processing unit can also send the detection data to the vehicle-mounted processor. The vehicle-mounted processor calculates the vehicle speed according to the detection data.

That is, in some embodiments, an execution subject of the vehicle speed calculation method is not limited, which can include the signal processing unit of the FMCW radar, the vehicle-mounted processor, or another device with data processing functions, for example, a server 12 shown in FIG. 1, other than the signal processing unit of the radar or the vehicle-mounted processor. In some embodiments, the vehicle 11 is further provided with a communication module. The communication module may include a wired communication module or a wireless communication module. Taking the wireless communication module as an example, when the radar of the vehicle 11, such as the antenna of the FMCW radar, receives the echo signal reflected by the object, the signal processing unit of the FMCW radar performs digital sampling of the echo signal. The vehicle 11 can send the sampled echo signal to the server 12 through the wireless communication module. The server 12 processes the sampled echo signal, and after obtaining the detection data, calculates the vehicle speed according to the detection data. Alternatively, after the signal processing unit of the FMCW radar or the vehicle-mounted processor obtains the detection data, the vehicle 11 may send the detection data to the server 12 through the wireless communication module. The server 12 calculates the vehicle speed according to the detection data. The vehicle speed calculation method will be described in detail below in conjunction with specific embodiments.

FIG. 2 is a schematic flow chart of a vehicle speed calculation method according to an example embodiment of the present disclosure. As shown in FIG. 2, the method consistent with the example embodiment includes following processes.

At S201, an echo signal is obtained and detection data in generated according to the echo signal.

The execution subject of the method in the example embodiment may include the signal processing unit of the FMCW radar, the vehicle-mounted processor, or the server 12 shown in FIG. 1. In some embodiments, the signal processing unit of the FMCW radar is used as an example to introduce the vehicle speed calculation method in detail.

Specifically, after the antenna of the FMCW radar receives the echo signal, the signal processing unit of the FMCW radar obtains the echo signal and performs an analog-to-digital conversion on the echo signal, that is, performs digital sampling on the echo signal and further performs a Fast Fourier Transformation (FFT) on the sampled echo signal. Specifically, the signal processing unit can perform a two-dimensional FFT, that is, a speed dimension FFT and a distance dimension FFT, on the sampled echo signal to get the detection data. Correspondingly, the detection data includes two-dimensional data including a distance dimension and a speed dimension. The distance dimension includes a plurality of distance units, and the speed dimension includes a plurality of speed units.

In some embodiments, the FMCW radar may include more than one antenna. For example, the FMCW radar includes a plurality of antennas. Each of the plurality of antennas may receive an echo signal simultaneously. The signal processing unit may perform an analog-to-digital conversion and a two-dimensional FFT on the echo signal received by each of the plurality of antennas, obtain the two-dimensional data including the distance dimension and the speed dimension corresponding to the each of the plurality of antennas, and perform a multi-channel incoherent accumulation on the two-dimensional data including the distance dimension and the speed dimension corresponding to the each of the plurality of antennas to obtain detection data. In some embodiments, one antenna corresponds to one channel. The detection data obtained after the multi-channel incoherent accumulation still includes two-dimensional data including a distance dimension and a speed dimension. The distance dimension includes a plurality of distance units, and the speed dimension includes a plurality of speed unit.

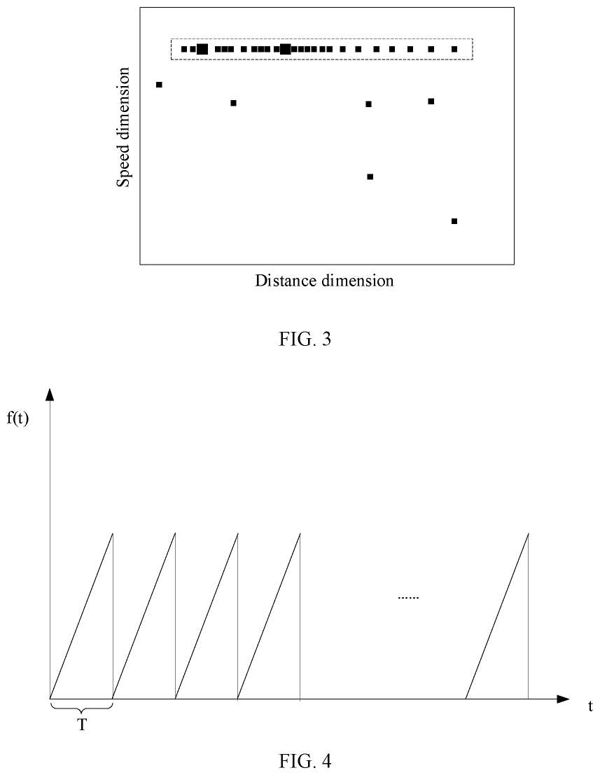

In an example embodiment, the two-dimensional data may specifically include an N*M matrix, that is, a matrix with N rows and M columns. FIG. 3 is a schematic diagram of two-dimensional data according to an example embodiment of the present disclosure. As shown in FIG. 3, a horizontal axis represents a distance dimension, a vertical axis represents a speed dimension. The speed dimension includes N speed units, the distance dimension includes M distance units. N and M can be equal or unequal. Both N and M are greater than 1. A point in the matrix can be used to represent a target point detected by the radar. A corresponding speed of the target point in the speed dimension represents a speed of the target point relative to the radar. A corresponding distance of the target point in the distance dimension represents a distance of the target point relative to the radar. In addition, in this matrix, energy of the points at different positions is different. As shown in FIG. 3, the points in a black part represent the target points with energy greater than a preset energy threshold. It can be understood that when the preset energy threshold is larger, the black part includes fewer points, and when the preset energy threshold is smaller, the black part includes more points. An value of the preset energy threshold is not limited here.

In an example embodiment, the detection signal of the FMCW radar includes a linear frequency-modulated continuous wave. A frequency of the linear frequency-modulated continuous wave changes periodically. FIG. 4 is a schematic diagram of a frequency of a linear frequency-modulated continuous wave changing with time according to an example embodiment of the present disclosure. As shown in FIG. 4, a horizontal axis represents time, i.e., t, and a vertical axis represents a frequency change of the linear frequency-modulated continuous wave with time, i.e., f(t). f(t) is in a pulse shape. T represents a pulse recurrent time (PRT), that is, a pulse period.

In some embodiments, a number of the plurality of speed units is positively correlated to a number of one or more periods of the frequency change of the detection signal. For example, the speed dimension includes N speed units. N is positively correlated to the number of one or more periods of f(t). Specifically, N is equal to a number of pulse periods, that is, a number of pulses.

In some embodiments, a number of the plurality of distance units is positively correlated to a number of one or more sampling points of the echo signal in one period. For example, the distance dimension includes M distance units. M may specifically represent the number of sampling points of the echo signal in one pulse period T.

At S202, a stationary object around the vehicle and stationary relative to a ground is determined according to the detection data.

As shown in FIG. 3, a stationary object around the vehicle and stationary relative to a ground can be determined according to the two-dimensional data, i.e., the N*M matrix. The stationary object can include a fence, guardrail, road shoulder, continuous stone pile, or greenbelt, etc., at a side of the lane where the vehicle is located. The target point corresponding to the stationary object has relatively large energy.

In some embodiments, the stationary object around the vehicle and stationary relative to the ground includes an object around the vehicle with energy greater than a preset energy threshold. As shown in FIG. 3, the points in the black part represent target points with energy greater than the preset energy threshold. The target points with energy greater than the preset energy threshold are further clustered. The fences, guardrails, road shoulders, continuous stone piles, or greenbelts at the side of the lane, which are stationary relative to the ground, are usually continuous. Therefore, relatively concentrated black points in a dashed box as shown in FIG. 3 can be used as the stationary objects near the vehicle and stationary relative to the ground.

At S203, a moving speed of the stationary object relative to the vehicle is determined.

As shown in FIG. 3, a speed corresponding to a point in the black part of the dashed box in the speed dimension is the moving speed of the stationary object relative to the vehicle.

At S204, a vehicle speed is determined according to the moving speed of the stationary object relative to the vehicle.

It can be understood that when the vehicle is moving, the stationary objects near the vehicle and stationary relative to the ground move relative to the vehicle. The moving speed of the stationary object relative to the vehicle and the vehicle speed relative to the ground, i.e., the vehicle speed, are equal in magnitude but opposite in direction. Therefore, after the moving speed of the stationary object relative to the vehicle is determined, a magnitude of the moving speed of the stationary object relative to the vehicle can be regarded as a magnitude of the vehicle speed, and an opposite direction of the moving speed of the stationary object relative to the vehicle can be regarded as a direction of the vehicle speed. However, this method is only applicable when the radar speed measurement is not ambiguous. An unambiguous speed measurement specifically refers to a detectable speed range.

In some embodiments, determining the vehicle speed according to the moving speed of the stationary object relative to the vehicle includes determining a detectable speed range of the radar according to a wavelength of a detection signal of the radar and a frequency change period of the detection signal, and when the moving speed of the stationary object relative to the vehicle is within the detectable speed range, determining the vehicle speed according to the moving speed of the stationary object relative to the vehicle.

For example, a wavelength of a detection signal of the FMCW radar is recorded as λ, a frequency change period of the detection signal of the FMCW radar is recorded as PRT, and an unambiguous speed measurement range of the FMCW radar is recorded as

$$- \frac{{V}_{max}}{2} to \frac{{V}_{max}}{2} .$$

The relationship between Vₘₐₓ, λ, and PRT is specifically shown in formula (1) as follows:

$${V}_{max} = \frac{λ}{2 P R T} \qquad ( 1 )$$

After the moving speed of the stationary object relative to the vehicle is calculated through the matrix shown in FIG. 3, whether the moving speed is within the unambiguous speed measurement range of the FMCW radar is further determined. If the moving speed is within the unambiguous speed measurement range of the FMCW radar, the magnitude of the moving speed of the stationary object relative to the vehicle can be regarded as the magnitude of the vehicle speed, and the opposition direction of the moving speed of the stationary object relative to the vehicle can be regarded as the direction of the vehicle speed.

In an example embodiment, the echo signal is obtained, and the detection data is generated according to the echo signal. According to the detection data, the moving speed of the stationary object, that is stationary relative to the ground and is around the vehicle, relative to the vehicle is determined. Furthermore, according to the moving speed of the stationary object relative to the vehicle, the vehicle speed is determined. That is, the vehicle speed can be determined by processing the echo signal. There is no need to obtain the vehicle speed from the CAN bus, which avoids the transmission delay of the CAN bus and enables to obtain the vehicle speed in real time, thereby improving a real-time nature of the obtaining of the vehicle speed and avoiding an impact on the performance of the radar. In addition, because there is no need to obtain the vehicle speed from the CAN bus, even if the radar is not mounted at the vehicle during the vehicle assembly, the radar can also be applied to aftermarket installed products.

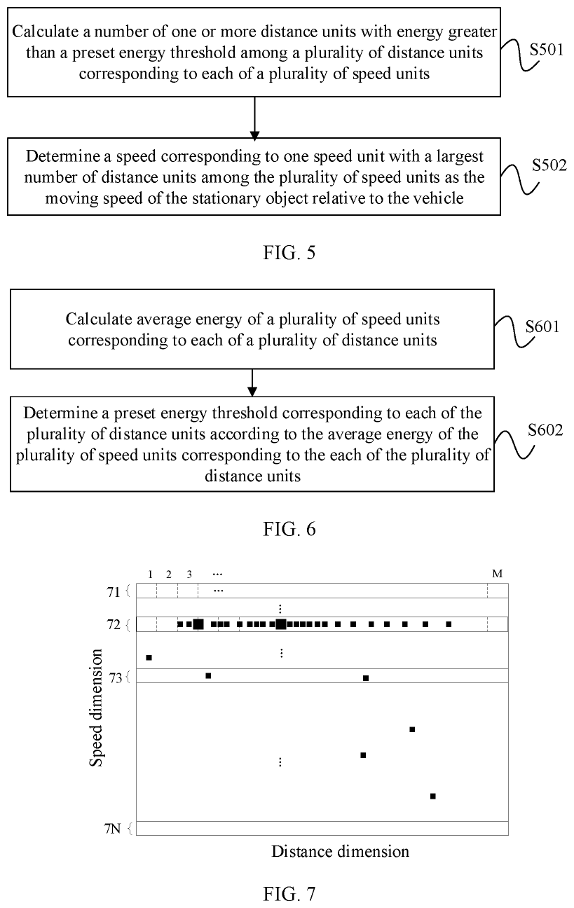

The vehicle speed calculation method consistent with the embodiments of the present disclosure is provided. FIG. 5 is a schematic flow chart of a vehicle speed calculation method according to another example embodiment of the present disclosure. FIG. 6 is a schematic flow chart of a vehicle speed calculation method according to another example embodiment of the present disclosure. As shown in FIG. 5, on the basis of the above-described embodiments, determining the moving speed of the stationary object relative to the vehicle includes following processes.

At S501, a number of one or more distance units with energy greater than a preset energy threshold among the plurality of distance units corresponding to each of the plurality of speed units is calculated.

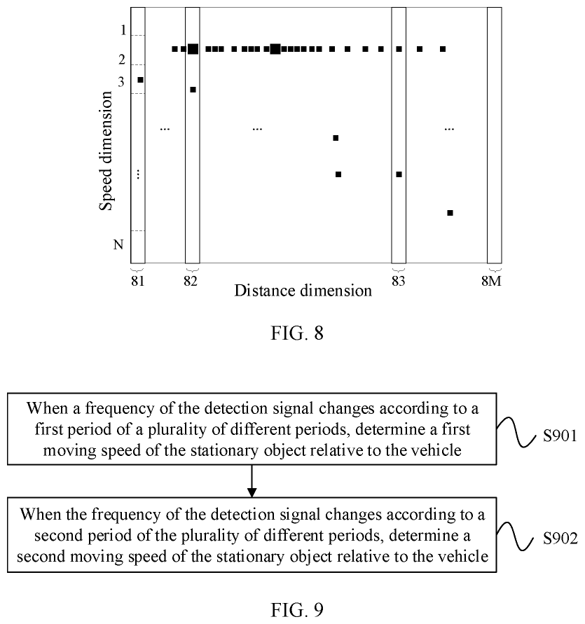

FIG. 7 is a schematic diagram of two-dimensional data according to an example embodiment of the present disclosure. As shown in FIG. 7, 71, 72, 73, . . . , 7N represent a plurality of speed units in the speed dimension, respectively. 71, 72, 73, and 7N are four random speed units in the plurality of speed units in the speed dimension. FIG. 8 is a schematic diagram of two-dimensional data according to an example embodiment of the present disclosure. As shown in FIG. 8, 81, 82, 83, . . . , 8M represent a plurality of distance units in the distance dimension, respectively. 81, 82, 83, and 8M are four random distance units in the plurality of distance units in the distance dimension.

As shown in FIG. 7, the plurality of distance units corresponding to each of the plurality of speed units may specifically include an intersection of the each of the plurality of speed units and the plurality of distance units in the distance dimension. As shown in FIG. 7, each of the plurality of speed units corresponds to M distance units. A number of one or more distance units with energy greater than the preset energy threshold among the plurality of distance units corresponding to each of the plurality of speed units is calculated. For example, a number of one or more distance units with energy greater than the preset energy threshold from M distance units corresponding to the speed unit 71 is calculated, a number of one or more distance units with energy greater than the preset energy threshold from M distance units corresponding to the speed unit 72 is calculated, and so on, and a number of one or more distance units with energy greater than the preset energy threshold from M distance units corresponding to the speed unit 7N is calculated.

In some embodiments, calculating the number of one or more distance units with energy greater than the preset energy threshold among the plurality of distance units corresponding to each of the plurality of speed units includes comparing the energy of each of the plurality of distance units corresponding to the each of the plurality of speed units with the preset energy threshold corresponding to the each of the plurality of distance units, if the energy of the each of the plurality of distance units is greater than the preset energy threshold corresponding to the each of the plurality of distance units, increasing a count corresponding to the each of the plurality of speed units by one.

In some embodiments, as shown in FIG. 8, each of the plurality of distance units in the distance dimension may correspond to a preset energy threshold, and the preset energy threshold corresponding to each of the plurality of distance unit may be the same or different. Taking the speed unit 71 as an example, energy of a first distance unit corresponding to the speed unit 71 is compared with a preset energy threshold corresponding to the first distance unit. If the energy of the first distance unit corresponding to the speed unit 71 is greater than the preset energy threshold corresponding to the first distance unit, a count corresponding to the speed unit 71 is increased by one. If the energy of the first distance unit corresponding to the speed unit 71 is less than or equal to the preset energy threshold corresponding to the first distance unit, the count corresponding to the speed unit 71 is not increased. Energy of a second distance unit corresponding to the speed unit 71 is further compared with a preset energy threshold corresponding to the second distance unit. If the energy of the second distance unit corresponding to the speed unit 71 is greater than the preset energy threshold corresponding to the second distance unit, then the count corresponding to the unit 71 is increased by one. If the energy of the second distance unit corresponding to the speed unit 71 is less than or equal to the preset energy threshold corresponding to the second distance unit, the count corresponding to the speed unit 71 is not increased. And so on, energy of a M^{th} distance unit corresponding to the speed unit 71 with a preset energy threshold corresponding to the M^{th} distance unit. If the energy of the M^{th} distance unit corresponding to the speed unit 71 is greater than the preset energy threshold corresponding to the M^{th} distance unit, then the count corresponding to the speed unit 71 is increased by one. If the energy of the M^{th} distance unit corresponding to the speed unit 71 is less than or equal to the preset energy threshold corresponding to the M^{th} distance unit, the count corresponding to the speed unit 71 is not increased. Finally, the count corresponding to the speed unit 71 is a number of one or more distance units with energy greater than the preset energy threshold from M distance units corresponding to the speed unit 71. In a similar manner, a number of one or more distance units with energy greater than the preset energy threshold from M distance units corresponding to the speed unit 72 and a number of one or more distance units with energy greater than the preset energy threshold from M distance units corresponding to any other speed unit can be calculated.

At S502, a speed corresponding to one speed unit with a largest number of distance units among the plurality of speed units is determined as the moving speed of the stationary object relative to the vehicle.

The number of one or more distance units with energy greater than the preset energy threshold from M distance units corresponding to each of the plurality of speed units are compared with each other, that is, the count corresponding to each of the plurality of speed unit are compared with each other. The points in the black part represent the target points with energy greater than the preset energy threshold. Thus, the number of distance units with energy greater than the preset energy threshold from M distance units corresponding to the speed unit 72 is the largest. The points in the black part of the dashed box represent stationary objects near the vehicle and stationary relative to the ground. Therefore, the speed corresponding to the speed unit 72 is the moving speed of the stationary object relative to the vehicle.

In some embodiments, before the number of one or more distance units with energy greater than the preset energy threshold among the plurality of distance units corresponding to each of the plurality of speed units is calculated, the method further includes following processes.

At S601, an average energy of the plurality of speed units corresponding to each of the plurality of distance units is calculated.

As shown in FIG. 8, the plurality of speed units corresponding to each of the plurality of distance units may specifically include the intersection of the each of the plurality of distance units and the plurality of speed units in the speed dimension. As shown in FIG. 8, each of the plurality of distance units corresponds to N speed units. An average energy of corresponding N speed units can be calculated for each of the plurality of distance units. The average energy of N speed units corresponding to each of the plurality of distance units may be the same or different. For example, an average energy of N speed units corresponding to the distance unit 81 is recorded as Pavg1.

At S602, a preset energy threshold corresponding to each of the plurality of distance units is determined according to the average energy of the plurality of speed units corresponding to the each of the plurality of distance unit.

A preset energy threshold corresponding to the distance unit 81 is determined according to the average energy Pavg1 of N speed units corresponding to the distance unit 81. The preset energy threshold corresponding to the distance unit 81 can be recorded as Pavg1+Z, where Z is selected based on a noise. In a similar manner, a preset energy threshold corresponding to another distance unit in the distance dimension can be calculated. For example, when the energy of the first distance unit corresponding to the speed unit 71 is compared with a preset energy threshold corresponding to the first distance unit, the preset energy threshold corresponding to the first distance unit is the preset energy threshold corresponding to the distance unit 81.

In an example embodiment, the number of one or more distance units with energy greater than the preset energy threshold among the plurality of distance units corresponding to each of the plurality of speed units is calculated. The speed corresponding to one speed unit with the largest number of distance units among the plurality of speed units is determined as the moving speed of the stationary object relative to the vehicle, thereby improving a calculation accuracy of the moving speed of the stationary object relative to the vehicle.

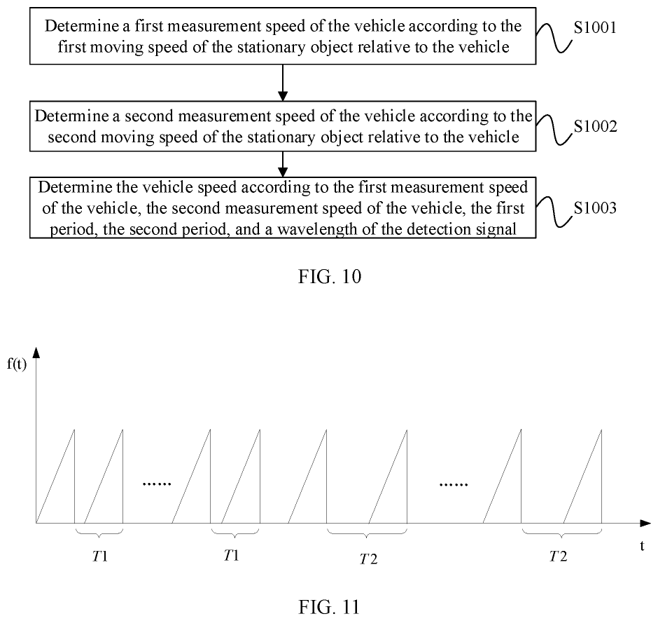

The vehicle speed calculation method consistent with the embodiments of the present disclosure is provided. FIG. 9 is a schematic flow chart of a vehicle speed calculation method according to another example embodiment of the present disclosure. FIG. 10 is a schematic flow chart of a vehicle speed calculation method according to another example embodiment of the present disclosure. FIG. 11 is a schematic diagram of a frequency of another linear frequency-modulated continuous wave changing with time according to an example embodiment of the present disclosure. As shown in FIG. 11, on the basis of the above-described embodiments, a frequency of a detection signal of the radar changes according to a plurality of different periods.

According to formula (1), due to a limitation of hardware conditions of the FMCW radar, the frequency change period PRT of the detection signal of the FMCW radar cannot be infinitely small, which causes the unambiguous speed measurement range of the FMCW radar to be a limited range. When the vehicle speed is relatively large, the vehicle speed determined according to the above method may be incorrect, which affects the performance of the radar system. In response to this problem, the frequency of the detection signal of the FMCW radar changes according to a plurality of different periods consistent is proposed in the embodiments of the present disclosure. The detection signal of the FMCW radar includes a linear frequency-modulated continuous wave. Taking a case where the frequency of the detection signal of the FMCW radar changes according to a first period and a second period as an example. The frequency of the linear frequency-modulated continuous wave changes with time as shown in FIG. 11. T1 represents the first period, and T2 represents the second period. It can be understood that this is only a schematic illustration, and a sequence of the first period and the second period is not limited here.

As shown in FIG. 9, determining the moving speed of the stationary object relative to the vehicle includes following processes.

At S901, when the frequency of the detection signal changes according to a first period of the plurality of different periods, a first moving speed of the stationary object relative to the vehicle is determined.

When the frequency of the detection signal of the FMCW radar changes according to the first period T1, according to the method described in the above embodiments, a first moving speed of the stationary object, that is stationary relative to the ground and is around the vehicle, relative to the vehicle can be calculated.

At S902, when the frequency of the detection signal changes according to a second period of the plurality of different periods, a second moving speed of the stationary object relative to the vehicle is determined.

When the frequency of the detection signal of the FMCW radar changes according to the second period T2, according to the method described in the above embodiments, a second moving speed of the stationary object, that is stationary relative to the ground and is around the vehicle, relative to the vehicle can be calculated.

Correspondingly, as shown in FIG. 10, determining the vehicle speed according to the moving speed of the stationary object relative to the vehicle includes following processes.

At S1001, a first measurement vehicle speed is determined according to the first moving speed of the stationary object relative to the vehicle.

According to the method described in the above embodiments, after the first moving speed of the stationary object relative to the vehicle is determined, a magnitude of the first moving speed of the stationary object relative to the vehicle can be regarded as the magnitude of the vehicle speed, and an opposite direction of the first moving speed of the stationary object relative to the vehicle is regarded as the direction of the vehicle speed, to obtain the first measurement vehicle speed. That is, the first measurement vehicle speed and the first moving speed of the stationary object relative to the vehicle are equal in magnitude but opposite in direction. The first measurement vehicle speed is recorded as V1.

At S1002, a second measurement vehicle speed is determined according to the second moving speed of the stationary object relative to the vehicle.

According to the method described in the above embodiments, after the second moving speed of the stationary object relative to the vehicle is determined, a magnitude of the second moving speed of the stationary object relative to the vehicle can be regarded as the magnitude of the vehicle speed, and an opposite direction of the second moving speed of the stationary object relative to the vehicle is regarded as the direction of the vehicle speed, to obtain the second measurement vehicle speed. That is, the second measurement vehicle speed and the second moving speed of the stationary object relative to the vehicle are equal in magnitude but opposite in direction. The second measurement vehicle speed is recorded as V2.

At S1003, the vehicle speed is determined according to the first measurement vehicle speed, the second measurement vehicle speed, the first period, the second period, and the wavelength of the detection signal.

The vehicle speed is determined according to the first measurement vehicle speed V1, the second measurement vehicle speed V2, the first period T1, the second period T2, and the wavelength λ of the detection signal. It can be understood that when the frequency of the detection signal of the FMCW radar changes according to a plurality of different periods, the wavelength λ of the detection signal does not change.

In some embodiments, determining the vehicle speed according to the first measurement vehicle speed, the second measurement vehicle speed, the first period, the second period, and the wavelength of the detection signal, includes determining a first vehicle speed according to the first measurement vehicle speed, the first period, and the wavelength of the detection signal, determining a second vehicle speed according to the second measurement vehicle speed, the second period, and the wavelength of the detection signal, and determining a target vehicle speed according to the first vehicle speed and the second vehicle speed.

For example, according to the first measurement vehicle speed V1, the first period T1, and the wavelength λ of the detection signal, the first vehicle speed is determined and is recorded as V1+mV1ₘₐₓ, where

$$V {1}_{max} = \frac{λ}{2 T 1} .$$

According to the second measurement vehicle speed V2, the second period T2, and the wavelength λ of the detection signal, the second vehicle speed is determined and is recorded as V2+nV2ₘₐₓ, where

$$V {2}_{max} = \frac{λ}{2 T 2} .$$

An actual vehicle speed is required to meet a condition described in formula (2) as follows:

V1+mV1ₘₐₓ=V2+nV2ₘₐₓ (2)

m and n are integers. According to formula (2), it can be known that the actual vehicle speed can be determined by selecting appropriate m, n, T1, and T2. A possible manner is traverse possible m and n existed to find the m and n satisfying a condition described in formula (3) as follows:

|(V1+mV1ₘₐₓ)−(V2+nV2ₘₐₓ)|<Threshold (3)

Threshold is a relatively small threshold value. Due to a limitation on the vehicle speed, a number of traversable m and n is limited, and a computation to find the m and n satisfying the condition described in formula (3) is not large.

After finding the m and n satisfying formula (3), the first vehicle speed, i.e., V1+mV1ₘₐₓ, and the second vehicle speed, i.e., V2+nV2ₘₐₓ, can be determined. Further, the actual vehicle speed can be calculated according to V1+mV1ₘₐₓ and V2+nV2ₘₐₓ. The actual vehicle speed is also the target vehicle speed finally required.

In some embodiments, determining the target vehicle speed according to the first vehicle speed and the second vehicle speed includes determining an average value of the first vehicle speed and the second vehicle speed as the target vehicle speed.

For example, an average value of V1+mV1ₘₐₓ and V2+nV2ₘₐₓ is calculated, and the average value is used as the target vehicle speed.

In an example embodiment, the frequency of the detection signal of the radar changes according to a plurality of different periods, a plurality of moving speeds of the stationary object, that is stationary relative to the ground and is around the vehicle, relative to the vehicle are calculated. A plurality of measurement vehicle speeds are determined according to the plurality of moving speeds of the stationary object relative to the vehicle. The actual vehicle speed is determined according to the plurality of measurement speeds, the plurality of different periods, and the wavelength of the detection signal, thereby avoiding the problem of inaccurate calculation of the vehicle speed caused by directly regarding the magnitude of the moving speed of the stationary object relative to the vehicle is directly as the magnitude of the vehicle speed when the actual vehicle speed exceeds the unambiguous speed measurement range of the radar, and improving a calculation accuracy of the actual vehicle speed.

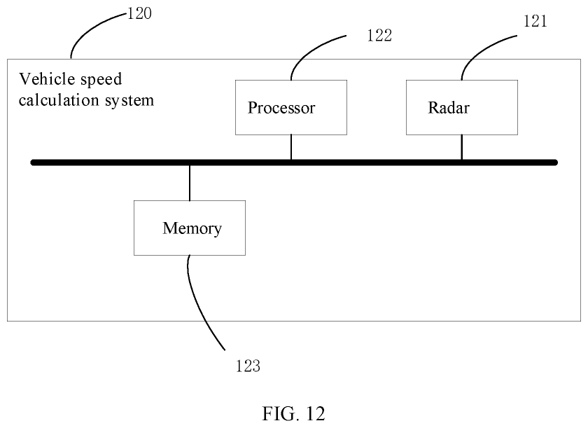

A vehicle speed calculation system consistent with the embodiments of the present disclosure is provided. FIG. 12 is a schematic structural diagram of a vehicle speed calculation system 120 according to an example embodiment of the present disclosure. As shown in FIG. 12, the vehicle speed calculation system 120 includes a radar 121, a memory 122, and a processor 123. The radar 121 is mounted at the vehicle. In a possible situation, the vehicle speed calculation system 120 specifically includes a radar system. In this scenario, the processor 123 may specifically include a signal processing unit of the radar 121. In another possible situation, the vehicle speed calculation system 120 specifically includes a vehicle with a radar mounted thereon. In this scenario, the processor 123 may specifically include a vehicle-mounted processor. In another possible situation, the vehicle speed calculation system 120 specifically includes a system including a vehicle with a radar mounted thereon and the server 12 as shown in FIG. 1. In this scenario, the processor 123 may specifically include a processor of the server 12.

Specifically, the radar 121 at least includes an antenna. The antenna is used to receive an echo signal. The memory 122 stores a program code. The processor 123 is configured to execute the program code to obtain the echo signal and generate detection data according to the echo signal, determine a stationary object around the vehicle and stationary relative to a ground according to the detection data, determine a moving speed of the stationary object relative to the vehicle, and determine a vehicle speed according to the moving speed of the stationary object relative to the vehicle.

In some embodiments, the detection data includes at least one of energy of an object around the vehicle, a distance of the object around the vehicle relative to the vehicle, a speed of the object around the vehicle relative to the vehicle, or an angle of the object around the vehicle relative to the vehicle.

In some embodiments, the stationary object around the vehicle and stationary relative to the ground includes an object around the vehicle with energy greater than a preset energy threshold.

In some embodiments, the detection signal of the radar includes a linear frequency- modulated continuous wave.

In some embodiments, the detection data includes two-dimensional data including a distance dimension and a speed dimension, the distance dimension includes a plurality of distance units, and the speed dimension includes a plurality of speed units.

In some embodiments, a number of the plurality of speed units is positively correlated to a number of one or more periods of one or more frequency changes of the detection signal.

In some embodiments, a number of the plurality of distance units is positively correlated to a number of one or more sampling points of the echo signal in a period.

In some embodiments, when the processor 123 is configured to execute the program code to determine the moving speed of the stationary object relative to the vehicle, the processor 123 is specifically configured to execute the program code to calculate a number of one or more distance units with energy greater than a preset energy threshold among the plurality of distance units corresponding to each of the plurality of speed units, and determine a speed corresponding to one speed unit with a largest number of distance units among the plurality of speed units as the moving speed of the stationary object relative to the vehicle.

In some embodiments, before the processor 123 is configured to execute the program code to calculate the number of the one or more distance units with the energy greater than the preset energy threshold among the plurality of distance units corresponding to the each of the plurality of speed units, the processor 123 is further configured to execute the program code to calculate average energy of the plurality of speed units corresponding to each of the plurality of distance units, and determine the preset energy threshold corresponding to each of the plurality of distance units according to the average energy of the plurality of speed units corresponding to the each of the plurality of distance units.

In some embodiments, when the processor 123 is configured to execute the program code to calculate the number of the one or more distance units with the energy greater than the preset energy threshold among the plurality of distance units corresponding to the each of the plurality of speed units, the processor 123 is specifically configured to execute the program code to compare the energy of each of the plurality of distance units corresponding to the each of the plurality of speed units with the preset energy threshold corresponding to the each of the plurality of distance units, if the energy of the each of the plurality of distance units is greater than the preset energy threshold corresponding to the each of the plurality of distance units, increase a count corresponding to the each of the plurality of speed units by one.

In some embodiments, when the processor 123 is configured to execute the program code to determine the vehicle speed according to the moving speed of the stationary object relative to the vehicle, the processor 123 is specifically configured to execute the program code to determine a detectable speed range of the radar according to a wavelength of a detection signal of the radar and a frequency change period of the detection signal, if the moving speed of the stationary object relative to the vehicle is within the detectable speed range, determine the vehicle speed according to the moving speed of the stationary object relative to the vehicle.

In some embodiments, a frequency of a detection signal of the radar changes according to a plurality of different periods.

In some embodiments, when the processor 123 is configured to execute the program code to determine the moving speed of the stationary object around the vehicle and stationary relative to the ground relative to the vehicle according to the detection data, the processor 123 is specifically configured to execute the program code to when the frequency of the detection signal changes according to a first period of the plurality of different periods changes, determine a first moving speed of the stationary object relative to the vehicle, when the frequency of the detection signal changes according to a second period of the plurality of different periods, determine a second moving speed of the stationary object relative to the vehicle.

In some embodiments, when the processor 123 is configured to execute the program code to determine the vehicle speed according to the moving speed of the stationary object relative to the vehicle, the processor 123 is specifically configured to execute the program code to determine a first measurement vehicle speed according to the first moving speed of the stationary object relative to the vehicle, determine a second measurement vehicle speed according to the second moving speed of the stationary object relative to the vehicle, and determine the vehicle sped according to the first measurement vehicle speed, the second measurement vehicle speed, the first period, the second period, and the wavelength of the detection signal.

In some embodiments, when the processor 123 is configured to execute the program code to determine the vehicle speed according to the first measurement vehicle speed, the second measurement vehicle speed, the first period, the second period, and the wavelength of the detection signal. In the case of speed, the processor 123 is specifically configured to execute the program code to determine a first vehicle speed according to the first measurement vehicle speed, the first period, and the wavelength of the detection signal, determine a second vehicle speed according to the second measurement vehicle speed, the second period, and the wavelength of the detection signal, and determine a target vehicle speed according to the first vehicle speed and the second vehicle speed.

In some embodiments, when the processor 123 is configured to execute the program code to determine the target vehicle speed according to the first vehicle speed and the second vehicle speed, the processor 123 is specifically configured to execute the program code to determine an average value of the first vehicle speed and the second vehicle speed as the target vehicle speed.

In some embodiments, the radar includes a millimeter wave radar.

The specific principles and implementation manners of the vehicle speed calculation system consistent with the embodiments of the present disclosure are similar to the above-described embodiments, which are omitted here.

A vehicle consistent with the embodiments of the present disclosure is provided. The vehicle includes a vehicle body, a power system, and the vehicle speed calculation system described in the above embodiments. The power system is mounted at the vehicle body to provide power. The implementation manners and specific principles of the vehicle speed calculation system are consistent with the above-described embodiments, which are omitted here.

In addition, a computer-readable storage medium consistent with the embodiments of the present disclosure is provided. The computer-readable storage medium storing a computer program. The computer program is executed by a processor to implement the vehicle speed calculation method described in the above embodiments.

In the embodiments of the present disclosure, it should be understood that the disclosed device and method may be implemented in other manners. For example, the devices described above are merely illustrative. For example, the division of units may only be a logical function division, and there may be other ways of dividing the units. For example, plurality of units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The above-described integrated unit may be implemented in hardware or hardware with a software functional unit.

The above-described integrated unit implemented in the form of a software functional unit may be stored in a computer-readable storage medium. The above-described software functional unit is stored in a storage medium and includes instructions to enable a computer device (such as a personal computer, a server, or a network device, etc.) or a processor to perform part or all of a method consistent with the embodiments of the present disclosure. The storage medium can be any medium that can store program codes, for example, a USB disk, a mobile hard disk, a read-only memory (ROM), a random access memory (RAM), a magnetic disk, or an optical disk.

Those skilled in the art can clearly understand that, for the convenience and conciseness of the description, a division of the above-described functional modules is used as an example only. In practical applications, the above-described functions can be allocated by different functional modules as required, that is, an internal structure of the device is divided into different functional modules to complete all or part of the functions described above. For a specific process of the device described above, reference may be made to the corresponding process in the above method embodiments, which is omitted here.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A vehicle speed calculation system comprising:
a radar mounted at a vehicle and including an antenna configured to receive an echo signal;
a memory storing a program code; and
a processor configured to execute the program code to:
obtain the echo signal and generate detection data according to the echo signal;
determine, according to the detection data, a stationary object around the vehicle and stationary relative to a ground;
determine a relative moving speed of the stationary object relative to the vehicle; and
determine a vehicle speed of the vehicle according to the relative moving speed of the stationary object.

2. The system of claim 1, wherein the detection data includes at least one of energy of each of one or more nearby objects around the vehicle, a distance of each of the one or more nearby objects relative to the vehicle, a speed of each of the one or more nearby objects relative to the vehicle, or an angle of each of the one or more nearby objects relative to the vehicle.

3. The system of claim 1, wherein the stationary object includes an object around the vehicle with energy greater than a preset energy threshold.

4. The system of claim 1, wherein a detection signal of the radar includes a linear frequency-modulated continuous wave.

5. The system of claim 4, wherein the detection data includes two-dimensional data including a distance dimension and a speed dimension, the distance dimension includes a plurality of distance units, and the speed dimension includes a plurality of speed units.

6. The system of claim 5, wherein a number of the plurality of speed units is positively correlated to a number of one or more periods of one or more frequency changes of the detection signal.

7. The system of claim 6, wherein a number of the plurality of distance units is positively correlated to a number of one or more sampling points of the echo signal in a period.

8. The system of claim 5, wherein the processor is further configured to execute the program code to:
calculate a number of one or more distance units with energy greater than a preset energy threshold among the plurality of distance units corresponding to each of the plurality of speed units; and
determine a speed corresponding to one speed unit with a largest number of distance units among the plurality of speed units as the relative moving speed of the stationary object.

9. The system of claim 8, wherein the processor is further configured to execute the program code to, before calculating the number of the one or more distance units with the energy greater than the preset energy threshold:
calculate average energy of the plurality of speed units corresponding to each of the plurality of distance units; and
determine the preset energy threshold corresponding to each of the plurality of distance units according to the average energy of the plurality of speed units corresponding to the each of the plurality of distance units.

10. The system of claim 8, wherein the processor is further configured to execute the program code to:
compare the energy of each of the plurality of distance units corresponding to the each of the plurality of speed units with the preset energy threshold corresponding to the each of the plurality of distance units; and
in response to the energy of the each of the plurality of distance units being greater than the preset energy threshold corresponding to the each of the plurality of distance units, increase a count corresponding to the each of the plurality of speed units by one.

11. The system of claim 1, wherein the processor is further configured to execute the program code to:
determine a detectable speed range of the radar according to a wavelength of a detection signal of the radar and a frequency change period of the detection signal; and
in response to the moving speed of the stationary object relative to the vehicle being within the detectable speed range, determine the vehicle speed according to the relative moving speed of the stationary object.

12. The system of claim 1, wherein a frequency of a detection signal of the radar changes according to a plurality of different periods.

13. The system of claim 12, wherein the processor is further configured to execute the program code to:
in response to the frequency of the detection signal changing according to a first period of the plurality of different periods, determine a first relative moving speed of the stationary object relative to the vehicle; and
in response to the frequency of the detection signal changing according to a second period of the plurality of different periods, determine a second relative moving speed of the stationary object relative to the vehicle.

14. The system of claim 13, wherein the processor is further configured to:
determine a first measurement vehicle speed according to the first relative moving speed of the stationary object;
determine a second measurement vehicle speed according to the second relative moving speed of the stationary object; and
determine the vehicle speed according to the first measurement vehicle speed, the second measurement vehicle speed, the first period, the second period, and a wavelength of the detection signal.

15. The system of claim 14, wherein the processor is further configured to execute the program code to:
determine a first vehicle speed according to the first measurement vehicle speed, the first period, and the wavelength of the detection signal;
determine a second vehicle speed according to the second measurement vehicle speed, the second period, and the wavelength of the detection signal; and
determine a target vehicle speed according to the first vehicle speed and the second vehicle speed.

16. The system of claim 15, wherein the processor is further configured to execute the program code to:
determine an average value of the first vehicle speed and the second vehicle speed as the target vehicle speed.

17. The system of claim 1, wherein the radar includes a millimeter wave radar.

18. A vehicle comprising:
a vehicle body;
a power system mounted at the vehicle body and configured to provide power; and
a vehicle speed calculation system including:
a radar mounted at a vehicle and including an antenna configured to receive an echo signal;
a memory storing a program code; and
a processor configured to execute the program code to:
obtain the echo signal and generate detection data according to the echo signal;
determine, according to the detection data, a stationary object around the vehicle and stationary relative to a ground;
determine a relative moving speed of the stationary object relative to the vehicle; and
determine a vehicle speed of the vehicle according to the relative moving speed of the stationary object.

19. A vehicle speed calculation method comprising:
obtaining an echo signal received by an antenna of a radar at a vehicle and generating detection data according to the echo signal;
determining, according to the detection data, a stationary object around the vehicle and stationary relative to a ground;
determining a relative moving speed of the stationary object relative to the vehicle; and
determining a vehicle speed of the vehicle according to the relative moving speed of the stationary object.

20. The method of claim 19, wherein the detection data includes at least one of energy of each of one or more nearby objects around the vehicle, a distance of each of the one or more nearby objects relative to the vehicle, a speed of each of the one or more nearby objects relative to the vehicle, or an angle of each of the one or more objects relative to the vehicle.
